(19) United States
(12) Patent Application Publication
(10) Pub. No.: US 2013/0250168 A1
(43) Pub. Date: Sep. 26, 2013

(54) SYSTEM, METHOD AND COMPUTER SOFTWARE PRODUCT FOR EXPOSURE CONTROL OF AN IMAGING DEVICE USING FLASH LAMP PULSES

(71) Applicant: LOCKHEED MARTIN CORPORATION, Bethesda, MD (US)

(72) Inventor: Edward Jozef Miesak, Windermere, FL (US)

(73) Assignee: LOCKHEED MARTIN CORPORATION, Bethesda, MD (US)

(21) Appl. No.: 13/849,923

(22) Filed: Mar. 25, 2013

Related U.S. Application Data
(60) Provisional application No. 61/614,906, filed on Mar. 23, 2012.

(51) Int. Cl. H04N 5/235

(52) U.S. Cl. CPC H04N 5/2353
USPC 348/367

(57) ABSTRACT

A system including a flash lamp configured to operate at least at a single pulse duration which is less than a shutter speed of an imaging device and a flash lamp pulse count controller configured to operate the flash lamp at a number of successive pulses as set by the count controller. The number of successive pulses is determined by an image exposure level taken by the imaging device with a shutter of the imaging device continuously opened as the flash lamp produces the number of successive pulses. A method is disclosed. A non-transitory processor readable storage medium, providing an executable computer program product, the executable computer program product comprising a computer software code that, when executed by a processor, causes the process to perform certain functions is also disclosed.

### CROSS-REFERENCE TO RELATED APPLICATIONS

This application claims the benefit of U.S. Provisional Application No. 61/614,906 filed Mar. 23, 2012, and incorporated herein by reference in its entirety.

### BACKGROUND

Embodiments relate to a light system and, more particularly, to controlling exposure with a flash lamp operating in pulses.

In the photography industry, a flash lamp is typically used to illuminate a target so that the target may be photographed with sufficient illumination to obtain a clear image of the target. A flash lamp is a thermal device that generates light as a result of heat. The light generated is a brief sudden burst of bright light. Such flash lamps are designed to produce an intense broad band output of light ranging from near infrared to ultraviolet-C (“UVC”).

If a camera works where there is too much light, a diameter of an aperture through which light reaches a lens may be reduced or an amount of time a shutter is opened during which the camera collects light may be shortened, meaning increased shutter speed. However, when used with certain flash lamps, regardless how much a shutter speed may be decreased or an aperture diameter increased, there may not be enough light in a single flash of the lamp to obtain a clear picture.

In a system used to image latent fingerprints on paper without any pretreatment, such as conventional methods for lifting fingerprints involving chemicals or powders applied to the fingerprint, it may be possible to use a broad range of imaging devices, including ordinary digital cameras, with a short pulse flash lamp to illuminate a fingerprint for capturing an image with a. camera where ridgelines are distinguishable. A short pulse flash lamp may produce the required wavelengths for the illumination process to occur in a manner that can be detected by, for instance, visual spectrum imaging devices (such as digital or film cameras). A long pulse flash lamp may not produce the requisite wavelengths for proper illumination or may not produce enough of the requisite illumination during the long pulse.

One difficulty in such systems is the light pulse duration from the short pulse flash lamp may be shorter than the shortest exposure time of the camera. For instance, the shortest exposure time on the camera may be 250 microseconds. The flash lamp pulse duration used in a fingerprint imaging system having such a camera may be less than 6 microseconds. Therefore, the camera shutter cannot be used to control an amount of light entering the camera from a single flash. Thus, users and manufacturers would benefit from a system or method capable of varying an amount of light hitting a sample and then scattering into the camera to provide sufficient illumination for the camera.

### SUMMARY

Embodiments relate to a system, method and computer program product for controlling a number of pulses a flash lamp operates to correspond with a shutter speed of a camera. The system comprises a flash lamp configured to operate at least at a single pulse duration which is less than a shutter speed of an imaging device and a flash lamp pulse count controller configured to operate the flash lamp at a number of successive pulses as set by the count controller. The number of successive pulses is determined by an image exposure level taken by the imaging device with a shutter of the imaging device continuously opened as the flash lamp produces the number of successive pulses.

The method comprises illuminating a target with a flash lamp configured to operate at least at a single pulse duration which is less than a shutter speed of an imaging device. The method also comprises operating the flash lamp at a number of successive pulses as set by a count controller. The method also comprises capturing image data of the target at a desired image exposure level by opening a shutter of the imaging device for a time period at least long enough to expose the target to the successive pulses of the flash lamp.

The computer software product comprises a non-transitory processor readable storage medium, providing an executable computer program product, the executable computer program product comprising a computer software code that, when executed on a processor, causes the processor to operate a flash lamp at a number of successive pulses as set by a count controller and capture image data at an image exposure level by opening a shutter of an imaging device for a time period at least long enough to expose a target to the successive pulses of the flash lamp.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a block diagram illustrating an embodiment of a system;

FIG. 2 shows a block diagram illustrating an embodiment of a method;

FIG. 3 shows a graphical representing exposure control;

FIG. 4 shows a graphical representing exposure control;

FIG. 5 shows a graphical representation of image brightness based on a number of flash lamp shots taken; and

FIGS. 6A-6D show pictorial representations of a latent fingerprint taken with a various number of flash lamp pulses.

### DETAILED DESCRIPTION

Embodiments are described herein with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to non-limiting example applications for illustration. Broadly speaking, a technical effect may be to reduce a thermal load on light source which is used to produce a light in a particular spectrum.

It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

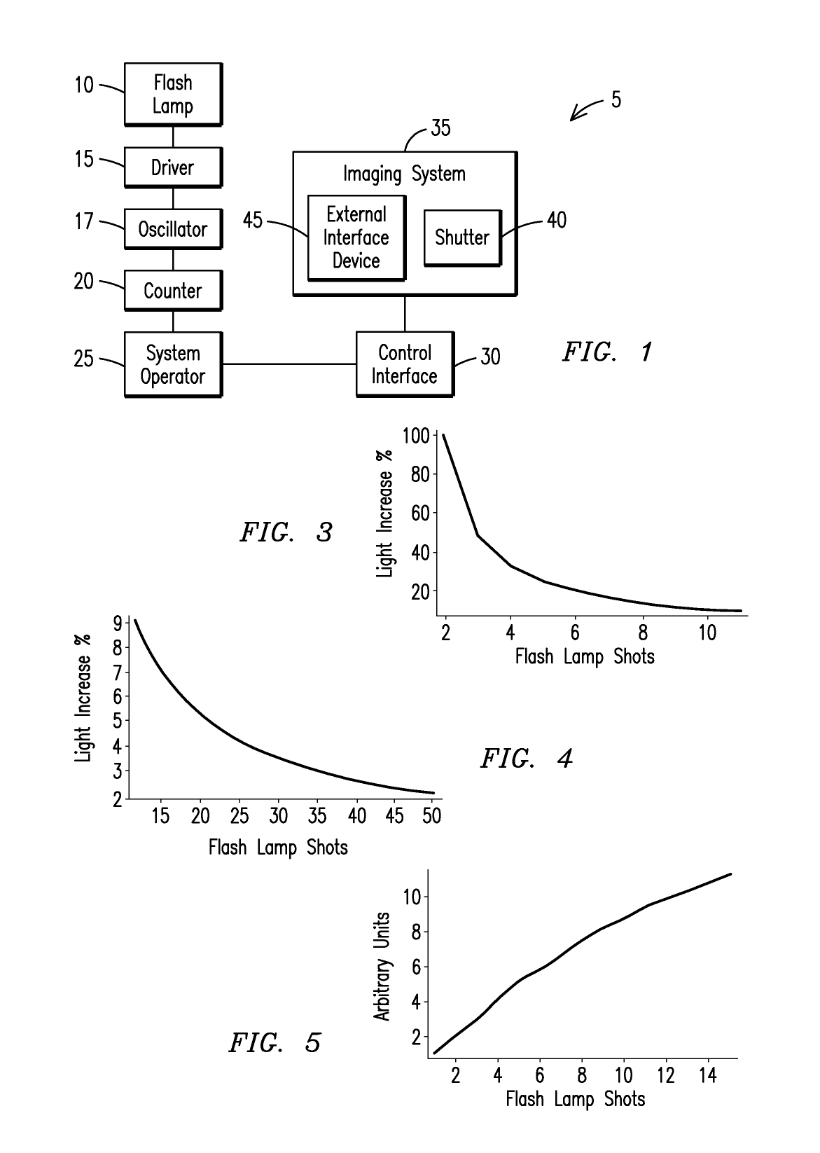

FIG. 1 shows a block diagram illustrating an embodiment of a system. In the system 5, a flash lamp 10 is provided. A flash lamp driver 15 is also provided. The flash lamp driver 15 may be configured to fire the flash lamp 10 continuously at a high repetition rate, i.e., 50 Hz or more (where more depends on a capability of the flash lamp and/or flash lamp driver). Depending on the flash lamp 10 used, the repetition rate may be at a frequency lower than the maximum possible flash lamp frequency. Running at a lower rate reduces an amount of heat generated by the flash lamp 10, and also extends a life of a battery powering the flash lamp driver 15. A counter 20 or similar device may be used to send a specific number of trigger pulses to the flash lamp driver 15.

A system operator 25 or some other parameter selecting component may select the number of times that the flash lamp 10 may fire. This may be directly selected or may be indirectly selected through an exposure or illumination level setting available through a control interface 30, such as, but not limited to, a screen, dial, button, keypad, or other control/input interface. A shutter 40 of an imaging system 35, or imaging device, in such a system 5 is set to remain open, or is continuously opened, until all the flash lamp pulses are delivered.

Within the imaging system, or camera, a number of flashes may be adjusted, such as, but not limited to, by visually or computationally inspecting an image captured at a given illumination level and then re-shooting the sample if necessary. Such a determination may be made either by the system operator 25 and/or by an automatic image analysis feature included in or operating in conjunction with the system operator. More specifically, the exposure level may be controlled by adjusting a number of flash lamp pulses being delivered to the sample being illuminated. Thus, the system operator may be in communication with the camera, though it does not have to be.

The exposure control may be accomplished several ways. In an embodiment, the camera shutter 40 may be set to one value that allows the maximum possible flash lamp shots to be captured. In a non-limiting example, if the flash lamp repetition rate is 50 Hz (20 msec between shots) and a maximum number of shots that will be used is 32, then the camera shutter 40 may be set to 0.64 seconds based on the calculation 32×0.02=0.64 seconds. The shutter speed therefore may remain constant and the number of pulses from the lamp 10 may be varied between 1 and 32, with more pulses providing more exposure. If a higher limit of more than 32 pulses is desired, the camera shutter time may be adjusted accordingly.

In an embodiment, the flash lamp driver input may be connected to an oscillator 17 which is connected to the flash lamp 10. Though an oscillator 17 is disclosed, another circuit may be provided which may be configured to operate, or run, the driver 15. In an embodiment, the driver 15 comprises the oscillator 17. In another embodiment, the oscillator 17 may be separate from, or not a part of, the driver 15, but may be provided to run the driver 15. In a non-limiting example, the oscillator frequency may be 50 Hz, but may be varied as desired or needed.

An external interface device 45 may be provided. Non-limiting examples of the external interface device 45 may include, but are not limited to a Hot Shoe connector, a universal serial bus (“USB”) port, other external trigger ports, etc. The external interface device 45 may be used to trigger the imaging system 35 resulting in opening of its shutter 40, such as, but not limited to, having a circuit (i.e., the driver 15 and oscillator 17) driving the flash lamp 10. The external interface device 45 may be provided to either activate the camera imaging function and/or to trigger illumination of the flash lamp 10.

As a non-limiting example, when the external interface device comprises a Hot Shoe connector 45 (where the flash lamp 10 may be attached to the camera and where there may be one-way communication from the camera to the flash lamp driver) it may be used to enable the oscillator 17 or the flash driver 15 to be activated. More specifically, the Hot Shoe connector 45 is used as a trigger to initiate the flash lamp to begin pulsing. A signal from the Hot Shoe connector may be configured to remain on as long as the camera shutter 40 remains open. More specifically, as long as the Hot Shoe connector is providing power or a signal, the flash lamp driver 15 may send pulses to the flash lamp 10 for the flash lamp to flash. The image exposure may then be controlled by adjusting the shutter opening duration. Other non-limiting variations may use other signal pathways, such as, but not limited to, a USB or other data connection, to feed a control or drive signal to a flash lamp or flash lamp controller portion.

Even though the non-limiting examples above used 50 Hz as the flash lamp repetition rate, any appropriate repetition rate can be used. Higher rates will reduce the maximum shutter time. However, at least for imaging latent fingerprints, operating the flash lamp with a high amount of power (to produce more UVC light) for short durations will reduce the amount of heat produced by the flash lamp.

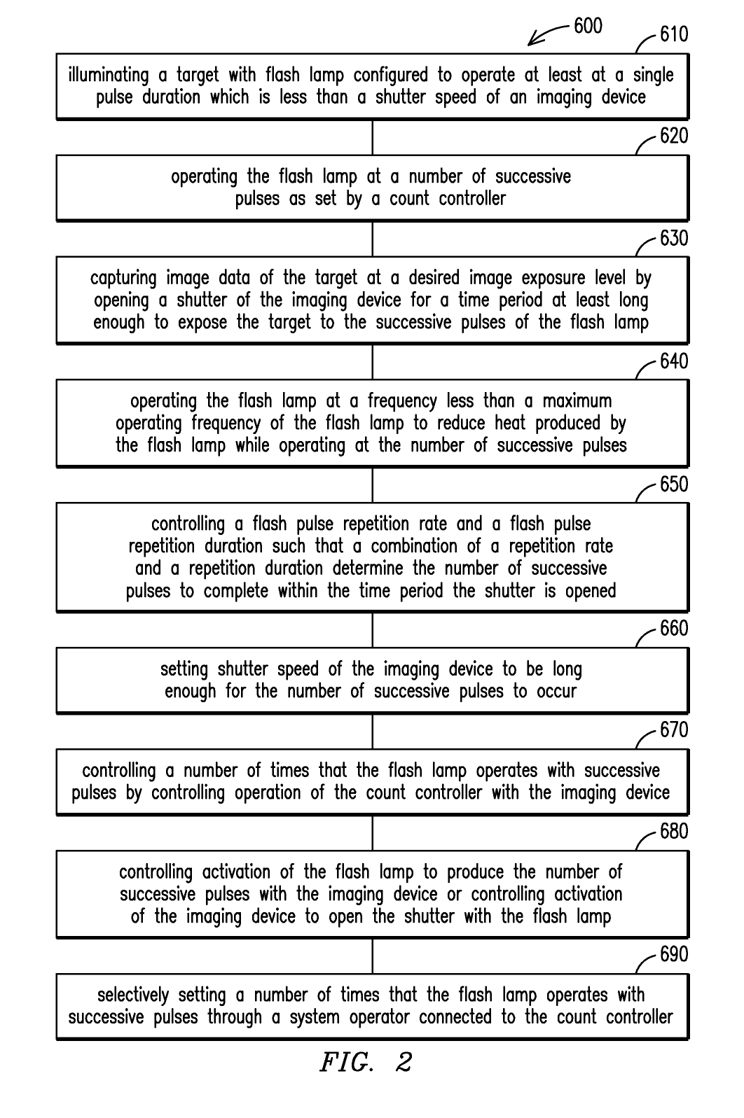

FIG. 2 shows a flowchart illustrating an embodiment of a method. The steps in the flowchart may not have to be performed in the sequence presented. The method 600 comprises illuminating a target with a flash lamp configured to operate at least at a single pulse duration which is less than a shutter speed of an imaging device, at 610. The method further comprises operating the flash lamp at a number of successive pulses as set by a count controller, at 620. The method further comprises capturing image data of the target at a desired image exposure level by opening a shutter of the imaging device for a time period at least long enough to expose the target to the successive pulses of the flash lamp, at 630.

The method may also comprise operating the flash lamp at a frequency less than a maximum operating frequency of the flash lamp to reduce heat produced by the flash lamp while operating at the number of successive pulses, at 640. The method may further comprise controlling a flash pulse repetition rate and a flash pulse repetition duration such that a combination of a repetition rate and a repetition duration determine the number of successive pulses being completed within the time period the shutter is opened, at 650. The method may further comprise setting shutter speed of the imaging device to be long enough for the number of successive pulses to occur, at 660. The method may further comprise controlling a number of times that the flash lamp operates with successive pulses by controlling operation of the count controller with the imaging device, at 670. The method may further comprise controlling activation of the flash lamp to produce the number of successive pulses with the imaging device or controlling activation of the imaging device to open the shutter with the flash lamp, at 680. The method may further comprise selectively setting a number of times that the flash lamp operates with successive pulses through a system operator connected to the count controller, at 690. An image exposure may be determined by a frequency at which the flash lamp is operated to produce the number of successive pulses and a duration the shutter of the imaging device is opened.

FIGS. 3 and 4 show a graphical representation of exposure control. The graphs compare a percentage of light to a number of flash lamp shots. As disclosed above, exposure is controlled by keeping the camera shutter open, or continuously opened, while a specific number of flash lamp pulses occur. A flash lamp with good pulse-to-pulse stability allows for the use of pulse counting as an accurate way to control image exposure, especially as the number of pulses increases. As a non-limiting example, two pulses are expected to produce an image twice as bright as one pulse because the amount of light has increased by one hundred percent (100%). Three pulses are expected to be fifty percent (50%) brighter than two pulses. Five pulses are expected to be twenty-five (25%) brighter than four pulses. Eleven pulses are expected to be ten percent (10%) brighter than ten pulses, and so on. Image exposures may increase very accurately in diminishing amounts as the number of pulses per shutter opening increase. FIG. 3 demonstrates this result up to about 11 shots whereas FIG. 4 demonstrates this result from about 11 shots up to about 50 shots.

FIG. 5 shows a graphical representation of image brightness based on a number of flash lamp shots taken. The number of flash lamp shots is compared to an arbitrary unit to illustrate that brightness increases as a number of flash lamp shots are increased. In an experiment, a series of fifteen images were taken of a single sample using a constant experimental setup. The only difference between the images was the number of flash lamp pulses that were used to expose the image. The first image was taken using one pulse, the second image used two pulses, and so on. The fifteenth image used fifteen flash lamp pulses. As illustrated, the vertical axis represents image brightness using arbitrary units. The horizontal axis represents the number of flash lamp pulses used to record an image. The plotted curve shows that image brightness increases as a number of flash lamp pulses increase.

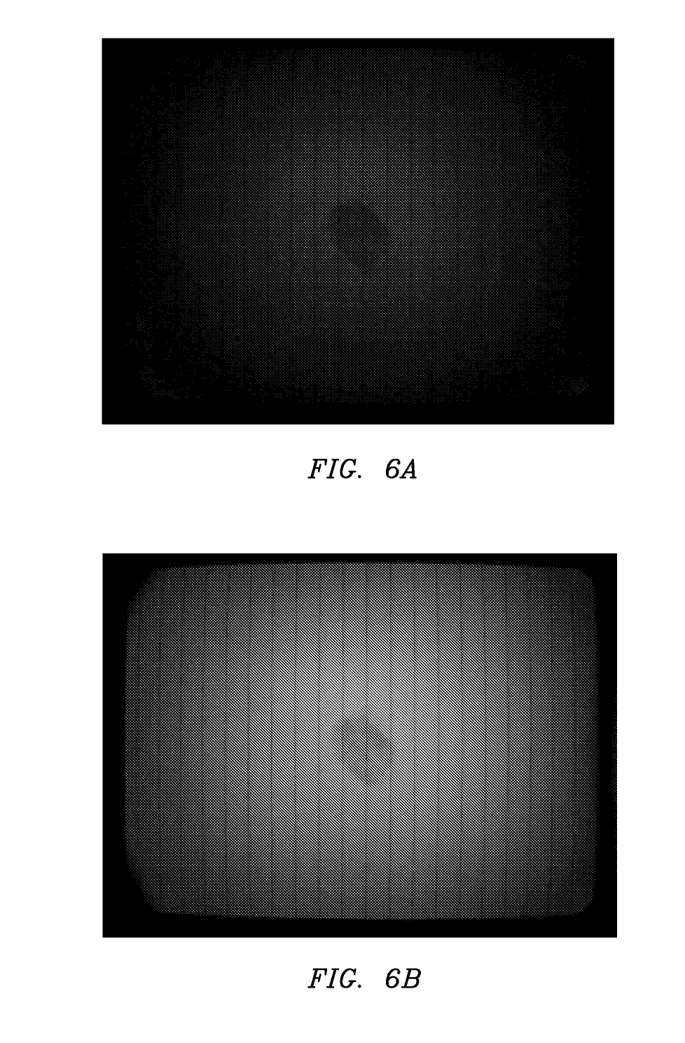

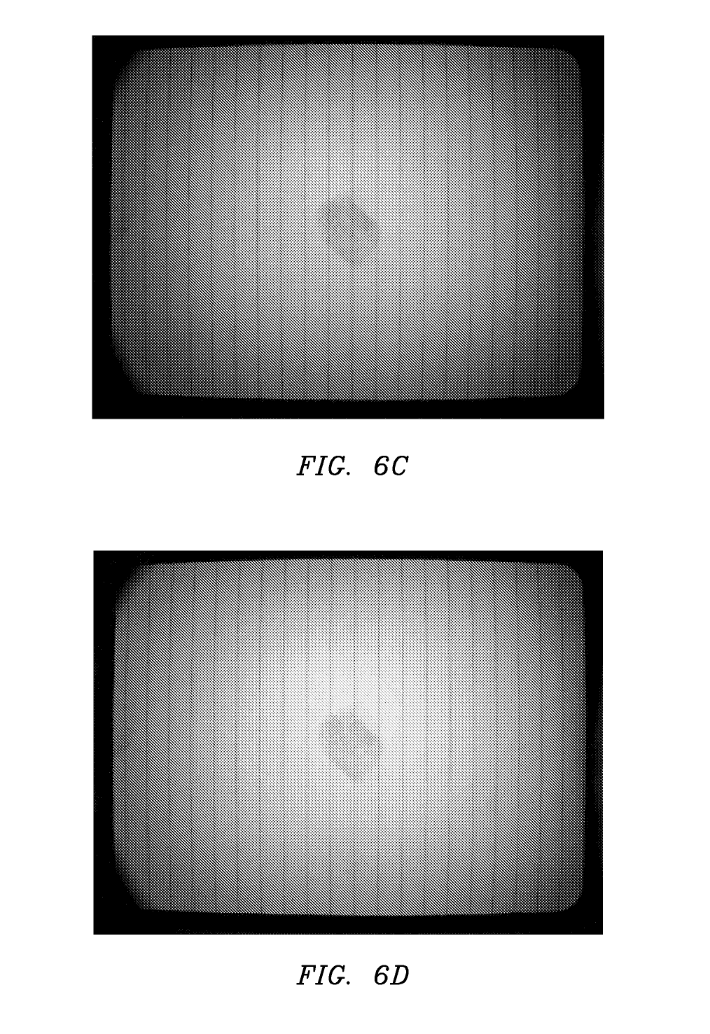

FIGS. 6A-6D show pictorial representations of a latent fingerprint taken with various number of flash lamp pulses. These photographs further illustrate the graph illustrated in FIG. 5. FIG. 6A is illustrative of the fingerprint taken with a single flash lamp pulse. FIG. 6B is illustrative of the fingerprint taken with 5 flash lamp pulses. FIG. 6C is illustrative of the fingerprint taken with 10 flash lamp pulses. FIG. 61) is illustrative of the fingerprint taken with 15 flash lamp pulses. As is viewable when comparing each image, the clarity of the fingerprint increases with more flash lamp pulses occurring when a shutter is continuously open.

Though disclosed above with respect to imaging latent fingerprints, embodiments are also applicable for other uses, such as, but not limited to, industrial inspections to ensure that there is no contamination on a particular device or product. In another non-limiting example, embodiments may also be used to inspect cloth material.

Based on what has been disclosed above, persons skilled in the art will recognize that an apparatus, such as a data processing system, including a CPU, memory, I/O, program storage, a connecting bus, and other appropriate components, could be programmed or otherwise designed to facilitate the practice of embodiments of the method. Such a system would include appropriate program means for executing the method.

Also, an article of manufacture, such as a pre-recorded disk, computer readable media, or other similar computer program product, for use with a data processing system, could include a storage medium and program means recorded thereon for directing the data processing system to facilitate the practice of the method.

Embodiments may also be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, objects, components, data structures, etc., that perform particular tasks or implement particular abstract data types. For example, the software programs that underlie embodiments can be coded in different programming languages, for use with different devices, or platforms. It will be appreciated, however, that the principles that underlie the embodiments can be implemented with other types of computer software technologies.

Moreover, those skilled in the art will appreciate that embodiments may be practiced with other computer system configurations, multiprocessor systems, microprocessor-based or programmable consumer electronics, minicomputers, mainframe computers, and the like. Embodiments may also be practiced in distributed computing environments where tasks are performed by processing devices located at different locations that are linked through at least one communications network. In a distributed computing environment, program modules may be located in both local and remote computer storage media including memory storage devices. In view of the above, a non-transitory processor readable storage medium is provided. The storage medium comprises an executable computer program product which further comprises a computer software code that may be executed on a processor.

In view of the above, a non-transitory processor readable storage medium is provided. The storage medium may comprise an executable computer program product which further comprises a computer software code that, when executed on a processor, causes the processor to operate a flash lamp at a number of successive pulses as set by a count controller and capture image data at an image exposure level by opening a shutter of an imaging device for a time period at least long enough to expose a target to the successive pulses of the flash lamp.

While various disclosed embodiments have been described above, it should be understood that they have been presented by way of example only, and not limitation. Numerous changes to the subject matter disclosed herein can be made in accordance with the embodiments disclosed herein without departing from the spirit or scope of the embodiments. In addition, while a particular feature may have been disclosed with respect to only one of several implementations, such feature may be combined with one or more other features of the other implementations as may be desired and advantageous for any given or particular application.

Thus, the breadth and scope of the subject matter provided herein should not be limited by any of the above explicitly described embodiments. Rather, the scope of the embodiments should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Thus, while embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered.

1. A system comprising:
a flash lamp configured to operate at least at a single pulse duration which is less than a shutter speed of an imaging device; and
a flash lamp pulse count controller configured to operate the flash lamp at a number of successive pulses as set by the count controller;
wherein the number of successive pulses is determined by an image exposure level taken by the imaging device with a shutter of the imaging device continuously opened as the flash lamp produces the number of successive pulses.

2. The system according to claim 1, further comprising a driver configured to operate the flash lamp at a frequency less than a maximum operating frequency to reduce an amount of heat produced by the flash lamp while operating at the number of successive pulses.

3. The system according to claim 1, wherein the flash lamp pulse controller controls a flash pulse repetition rate and a flash pulse repetition duration such that a combination of a repetition rate and a repetition duration determine the number of successive pulses to complete within a time period the shutter is continuously opened.

4. The system according to claim 1, wherein the imaging device comprises a camera and wherein a shutter speed of the camera is set to be long enough for the number of successive pulses to occur.

5. The system according to claim 1, wherein the flash lamp pulse count controller is operably connected to the imaging device.

6. The system according to claim 5, wherein the imaging device controls a number of times that the flash lamp operates with successive pulses by controlling operation of the count controller.

7. The system according to claim 5, further comprising an external interface device configured through which control of the flash lamp is performed by operation of the imaging device or control of the imaging device is performed by operation of the flash lamp wherein operation by the imaging device or flash lamp provides for the successive pulses occurring while the shutter is continuously opened.

8. The system according to claim 1, wherein the count controller comprises a system operator to allow for selectively setting a number of successive pulses that the flash lamp produces.

9. A method comprising:
illuminating a target with a flash lamp configured to operate at least at a single pulse duration which is less than a shutter speed of an imaging device;
operating the flash lamp at a number of successive pulses as set by a count controller; and
capturing image data of the target at a desired image exposure level by opening a shutter of the imaging device for a time period at least long enough to expose the target to the successive pulses of the flash lamp.

10. The method according to claim 9, wherein an image exposure is determined by a frequency at which the flash lamp is operated to produce the number of successive pulses and a duration the shutter of the imaging device is opened.

11. The method according to claim 9, further comprising operating the flash lamp at a frequency less than a maximum operating frequency of the flash lamp to reduce heat produced by the flash lamp while operating at the number of successive pulses.

12. The method according to claim 9, further comprising controlling a flash pulse repetition rate and a flash pulse repetition duration such that a combination of a repetition rate and a repetition duration determine the number of successive pulses to complete within the time period the shutter is opened.

13. The method according to claim 9, further comprising setting shutter speed of the imaging device to be long enough for the number of successive pulses to occur.

14. The method according to claim 9, further comprises controlling a number of times that the flash lamp operates with successive pulses by controlling operation of the count controller with the imaging device.

15. The method according to claim 9, further comprising controlling activation of the flash lamp to produce the number of successive pulses with the imaging device or controlling activation of the imaging device to open the shutter with the flash lamp.

16. The method according to claim 9, further comprising selectively setting a number of times that the flash lamp operates with successive pulses through a system operator connected to the count controller.

17. A non-transitory processor readable storage medium, providing an executable computer program product, the executable computer program product comprising a computer software code that, when executed on a processor, causes the processor to:
operate a flash lamp at a number of successive pulses as set by a count controller; and
capture image data at an image exposure level by opening a shutter of an imaging device for a time period at least long enough to expose a target to the successive pulses of the flash lamp.

18. The non-transitory processor readable storage medium of claim 17, wherein the processor is further caused to operate the flash lamp at a frequency less than a maximum operating frequency of the flash lamp to reduce heat produced by the flash lamp while operating at the number of successive pulses.

19. The non-transitory processor readable storage medium of claim 17, wherein the processor is further caused to control a flash pulse repetition rate and a flash pulse repetition duration such that a combination of a repetition rate and a repetition duration determine the number of successive pukes responsive being completed within the time period the shutter is opened.

20. The non-transitory processor readable storage medium of claim 17, wherein the processor is further caused to control activation of the flash lamp to produce the number of successive pulses with the imaging device or control activation of the imaging device to maintain the shutter opened with the flash lamp.
